(19) United States
(12) Patent Application Publication
(10) Pub. No.: US 2001/0047274 A1
(43) Pub. Date: Nov. 29, 2001

(54) Activity-based business modeling

(76) Inventor: Gregory F. Borton, Tiburon, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/813,636

(22) Filed: Mar. 21, 2001

Related U.S. Application Data
(60) Provisional application No. 60/190,867, filed on Mar. 21, 2000.

(51) Int. Cl. G06F 17/60; G06G 7/48

(52) U.S. Cl. 705/1; 703/6

(57) ABSTRACT

According to the invention, a method for activity-based business modeling for an organization is disclosed. In one step, at least two of an activity entry, a task entry, a resource entry, and a system entry are processed. At least two of the activity entry, the task entry, the resource entry, and the system entry are mapped together. After the processing, a forward-looking report is generated. The report is related to at least two of the activity entry, the task entry, the resource entry, and the system entry.

This application claims priority from U.S. Provisional Application No. 09/190,867 filed on Mar. 21, 2000 which is incorporated by reference herein.

### BACKGROUND OF THE INVENTION

This invention relates in general to business planning and, more specifically, to business projections, scenario management, and activity-based costing methods for business planning.

Conventional activity-based costing software starts with a defined general ledger, balance sheet or similar information. The line items on the general ledger are attributed to activities. For example, an expense for photocopier maintenance may be attributed back to a number of groups in the organization that use the photocopier by dividing the expense using some formula. Massive amounts of consulting fees are typically required to properly attribute back the general ledger to activities in the organization. The conventional activity-based costing software programs require a general ledger, balance sheet or surrogate thereof. Typically, general ledgers are only available for whole organizations and not for subsets of an organization.

### BRIEF DESCRIPTION OF THE DRAWINGS

The present invention is hereinafter described in conjunction with the appended drawing figure(s):

FIG. 1 is a block diagram of an embodiment of an activity-based modeling system;

FIG. 2A is a block diagram that schematically illustrates a definition flow for an embodiment of an activity-based model;

FIG. 2B is a block diagram that schematically illustrates a portion of a definition flow for an embodiment of the activity-based model;

FIG. 2C is a block diagram that schematically illustrates a portion of a definition flow for another embodiment of an activity-based model;

FIG. 3 is a flow diagram of an embodiment of a method for modeling an activity-based system; and

FIG. 4 is a flow diagram of an embodiment for designing templates used in the activity-based modeling system.

### DESCRIPTION OF THE SPECIFIC EMBODIMENTS

The present invention relates to activity-based modeling and planning methods for business planning. Activity, task, resource, and system information is gathered from templates or user entry to develop an activity-based modeling system. The templates contain typical values for the activities, tasks, resources, systems such that quick estimates are possible. Once the model is populated with information, forward-looking reports are generated.

In the Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

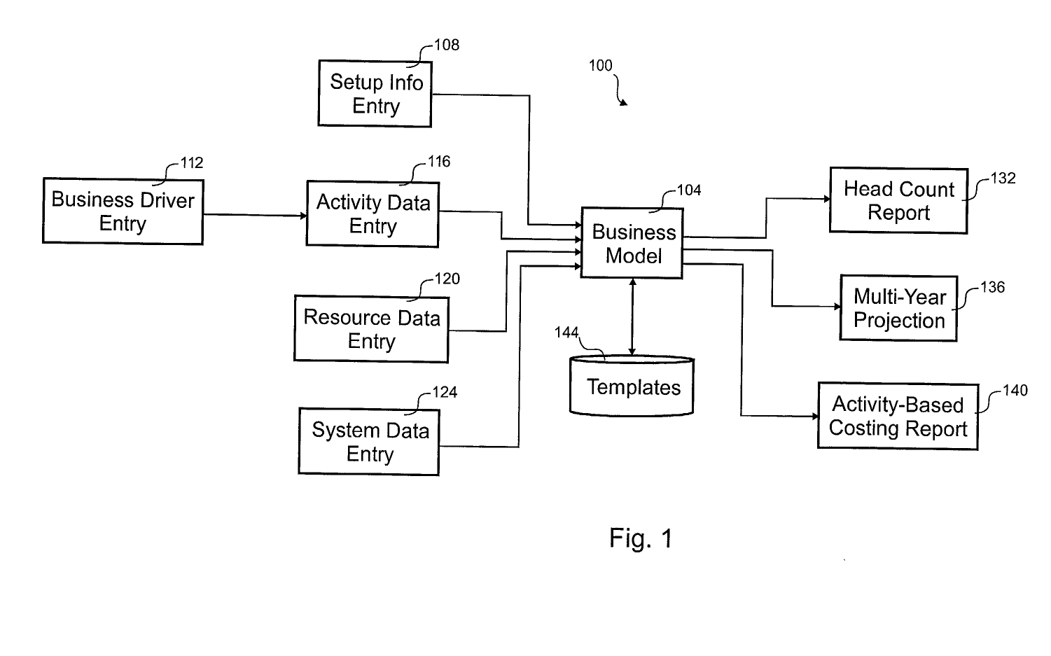

Referring first to FIG. 1, a block diagram of an embodiment of an activity-based modeling system 100 is shown. A business model 104 takes information from business driver entry 112, setup information entry 108, activity data entry 116, task data entry 118, resource data entry 120, and system data entry 124 along with any pre-population from the templates 144 to generate forward-looking reports 132, 136, 140. The reports include, but are not limited to, a head count report 132, a multi-year projection 136, and an activity-based costing report 140.

The business model 104 is software that typically runs on a general-purpose computer. For example, the business model 104 could run under Microsoft Windows™ on an IBM compatible computer. Some embodiments of the software could be interpreted by another program such as JAVA™ or Microsoft Excel™. Information is gathered by the business model 104 from the various data entry screens 108, 112, 116, 120, 124 and processed to produce reports 132, 136, 140 on the screen or in hard-copy form. The template database 144 is used to pre-populate any of the data entry screens 108, 112, 116, 120, 124 such that a user can quickly get results from the system 100.

Building the activity-based modeling system 100 typically begins with entry of setup information 108. In this embodiment, setup information 108 includes demographic information, scope of the model, start date of the model, budget assessments, variable personnel, and fixed personnel. The demographic information includes, for example, contact information and other information used to identify the program output. The scope of the model is used to identify the scope of the output generated by the program, hereinafter the scope for the model is called an organization. The scope of the organization could be a project(s), department(s) or a whole company or companies. A general ledger or balance sheet corresponding to the organization that reflects past performance is not required. A start date of the modeling system 100 is chosen and will serve as the beginning of results from the system 100. Any day in the future or past can be used as the start date.

Budget assessments for the organization are entered as part of the setup information 108. Specifying the assessments as a single unit attributable to the organization avoids entering this information for individual personnel or systems, however, other embodiments could enter the information individually for each employee or specify a system to account for the budget assessment. Budget assessments could include information technology, utilities, training, supplies, postage, travel, and marketing that are attributed to the organization as a whole.

Personnel falls into two categories: fixed personnel and variable personnel. A formula for compensation is developed that includes salary, bonus, overtime, benefits, typical annual raise, etc. for all personnel. Additionally, holidays, job turnover, hiring costs, travel, training and relocation costs also form part of the formula for determining the cost of an employee. Outsourcing of tasks and use of consultants can also be factored in to the modeling system 100 by incorporating their costs as a personnel system that can be scaled with the activity volume.

Fixed personnel are not automatically scaled by the system 100 as the volume of activity scales. For example, the number of executives and high-level managers may not change in a discernable way as activity scales, but the number of fixed personnel in any category can be manually scaled such that the system 100 can account for changes. A headcount over time is entered for each category of fixed employee to allow for manual scaling.

Variable personnel resources hold variable personnel as well as fixed personnel. In general, resources are a set of systems that are linked to activities. A resource may or may not have any personnel systems specified within it such that the resource is just a collection of hardware, software and/or services. The variable personnel resources are linked to activities such that their headcount scales with the activity volume and demand. For variable personnel, a cost while on the phone and a cost while off the phone is calculated based upon the cost of the phone service. When a personnel system is selected for the modeling system 100 either the on- or the off-phone option is selected. Other embodiments could add the phone cost as a system cost as explained further below. The headcount over time is not required for personnel systems as it is a function of the demand from the activity volume. To allow for scaling of personnel systems, relationships between a personnel system and activities are defined. For example, another longshoreman may be required for vessel unloaded with cargo that weighs over two hundred tons.

Systems used by variable personnel are specified such that usage of those systems is scaled as demand for the variable personnel changes. Variable personnel may use computer systems, office space, office supplies, training, human resources, etc. The setup information entry 108 is used to record the non-personnel systems needed to support a variable employee.

Variable personnel can also scale as a function of other variable personnel. As activity volume increases, so do the associated variable personnel required and their management personnel and support personnel. For example, a technical support employee may be required for every twelve customer service agents such that an increase in activity requiring twenty-four new customer service agents would also require two new technical support employees. As the technical support personnel scaled, so would the systems they rely upon.

The modeling of the business typically begins with a strategic plan that has strategic assumptions. These strategic assumptions are translated into business drivers. The business drivers typically vary over some time period. In this embodiment, the time granularity is in months, but other embodiments could use any time granularity such as quarter years, days, hours, minutes, seconds, etc. In the business driver entry screen 112, business drivers are correlated to an activity volume that is specified over a number of time periods or months. For example, the business driver may be increasing sales over the next three months such that the first month has ten sales, the second month has twenty sales and the third month has thirty sales. The activity volume for these months is respectively ten, twenty and thirty sales. Another way to enter the activity volume is to state an initial value along with annual growth such that the monthly volume is linearly extrapolated.

Once the activity volume for a business driver is determined over a number of time periods, the activity data entry 116 is typically performed by defining tasks for each activity. For a particular activity volume, one or more tasks are defined for accomplishing one unit of the activity. There are typically a number of tasks required to accomplish an activity. One example of an activity would be to generate a sale. Tasks required to generate a sale could include research, cold calls, and follow-up letters.

For each task an amount of time is specified for the task along with a task scale factor. The task scale factor indicates how many times on average the task is performed before accomplishing the activity. For example, ten cold calls may be required to make a sale (i.e., 1000% of cold calls result in a sale), but only one in five of the sales will require prior research (i.e., 20% of sales are researched).

Rather than having the same task scale factor for each time period, the task scale factor can be specified for each time period or month such that it varies over time. For example, many more cold calls may be initially required for a new product. But, as the customers become more educated through an advertising campaign, for example, the number of cold calls required for a sale may decrease.

In this embodiment, the tasks are unique to the activity such that different activities do not share task definitions with their associated time amounts and task scale factors. Other embodiments could share tasks among activities where the time amounts and scale factors can be uniquely defined.

For each task in this embodiment, a resource is assigned. A resource can include any number of personnel systems and/or other non-personnel systems. When a task is specified, a resource data entry screen 120 may be accessible in order to input all the systems that form the resource associated with the task. In other embodiments, the resources are set up separately or are pre-specified in a template 144 such that the resource data entry screen 120 is used only to assign a resource to a task. A resource is a collection of systems that may include personnel systems and non-personnel systems. For example, a resource may be a collection of non-personnel systems such as a computer server, a web site software license, access to a database system, etc.; or, a variable employee and the associated non-personnel systems that support that employee, such as computers, software, office space, training, etc. Variable employees are entered with the setup information 108 as described above and non-personnel systems are entered in the system data entry screen 124 as described below.

A resource is linked to a task that is linked to an activity such that the demand for the resource scales with the activity volume. For example, a variable personnel system can be assigned to a resource and an activity (or multiple activities in other embodiments) such that the demand for the resource translates into the demand for each of its constituent systems such as the variable labor employee, their training, offices, personal computers, software licenses and/or telephone usage. The demand for systems is automatically scaled based on the demand for the resource across all the activities that may be linked to that resource. Those skilled in the art can appreciate, that the total headcount is automatically calculated as a function of the activity volume, as well as the number of PCs, software license, telephone usage, offices and any other items to support.

For each resource, a usage-related factor and resource scale factor is specified. The usage factor could be the number of transactions used in some embodiments or the time period the resource is used in other embodiments. The usage factor defines how much of the resource is used to accomplish the task and the resource scale factor defines the weighting relative to the activity. For example, it might take one or more trips to the library for a sales associate to perform a research task associated with a sale activity. The research normally takes ten minutes, but twenty percent of the time requires a second ten-minute trip. In this example, the time period is ten minutes and the research scale factor of 120%. As another example, sometimes a sale activity requires a phone call to a toll-free phone system. The toll-free call usually lasts three minutes, but occasionally the technical support issue is solved early such that the research scale factor could be 90%, for example, with a three minute time period.

A system associated with a resource may be tied to the resource even though the system may not yet be available. When the system becomes available, the business model 104 automatically starts to use the new system. For example, one could specify use of a color printer system or a service bureau system for a color copying task. Initially, the service bureau system is used to accomplish the task. Once the color printer system becomes available, however, the resource automatically switches to the new color printer system with any efficiencies or cost reductions factored into the modeling system 100.

As first mentioned above, systems are input into the modeling system 100 with the system data entry screen 124. Non-personnel systems could be computers, software, offices, training, a software license, a database, or any other things purchased by the organization. This system screen 124 allows determining the cost of a non-personnel system and its effect on productivity. The system cost can be specified with the lease/license/loan terms, depreciation, chargeback assessment, and/or other cost factors. The system integration, additional personnel, productivity effects are entered to allow adding new tasks and/or scaling the current tasks. Impact on other systems such as positive or negative synergy (cross-elasticity) or replacement of other systems can also be defined. How the new system impacts the modeling system 100 can also be specified such as whether: the system costs appear in the budget, the system integration costs appear in the budget, the installation costs appear in the budget, the additional personnel appear in the headcount and budget, and productivity effects should show in the modeling system 100. Existing systems or planned purchases can be entered into the data entry screen 124.

As mentioned above, much of the data entry into the business model 104 is reduced by using templates stored in a database 144. The business drivers, setup information, personnel, activities, tasks, resources, and systems for many common business areas are available in templates to pre-populate the various data entry screens 108, 112, 116, 120, 124. A user can select templates 144 individually or can have the modeling system 100 question the user until an educated guess can be made as to which templates may be used. Surveys are made of the production sites using the modeling system 100 in various business areas to develop typical values that may be used in the templates 144. As an example, the templates 144 could provide all the model information typically required for a power utility's billing organization. A new customer with a similar organization would only have to tweak the templates 144 before generating meaningful reports 132, 136, 140 with the modeling system 100.

The business model 104 generates many forward-looking reports 132, 136, 140. Examples include the head count report 132, the multi-year projection 136, and activity-based costing report 140. Reports such as a weighted average headcount by job type, a fully allocated cost per employee over time, compensation costs by category are just some of the head-count reports 132. The multi-year projection reports 136 can include a fully allocated multi-year budget or a multi-year cash flow projection. Some of the activity-based costing reports 140 include task costs for each activity, activity volume over time, weighted marginal cost for an activity over time, and total marginal cost for an activity over time. The above are just some of the reports that are possible and other embodiments may produce standard business reports of any conceivable configuration.

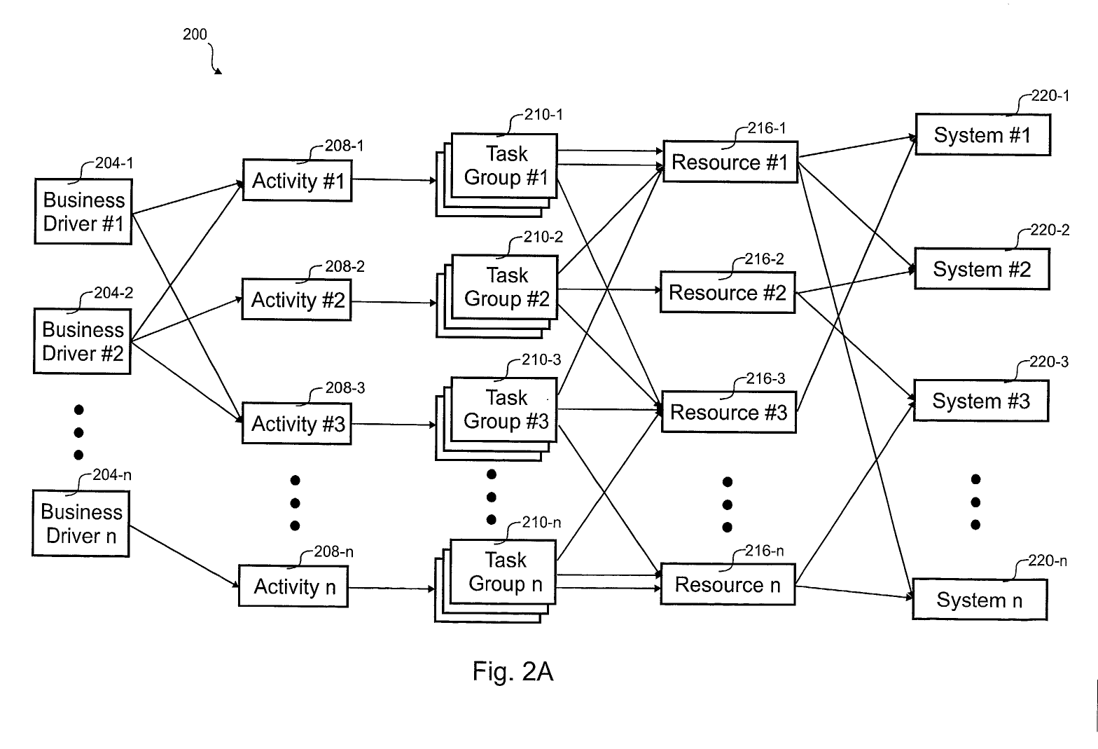

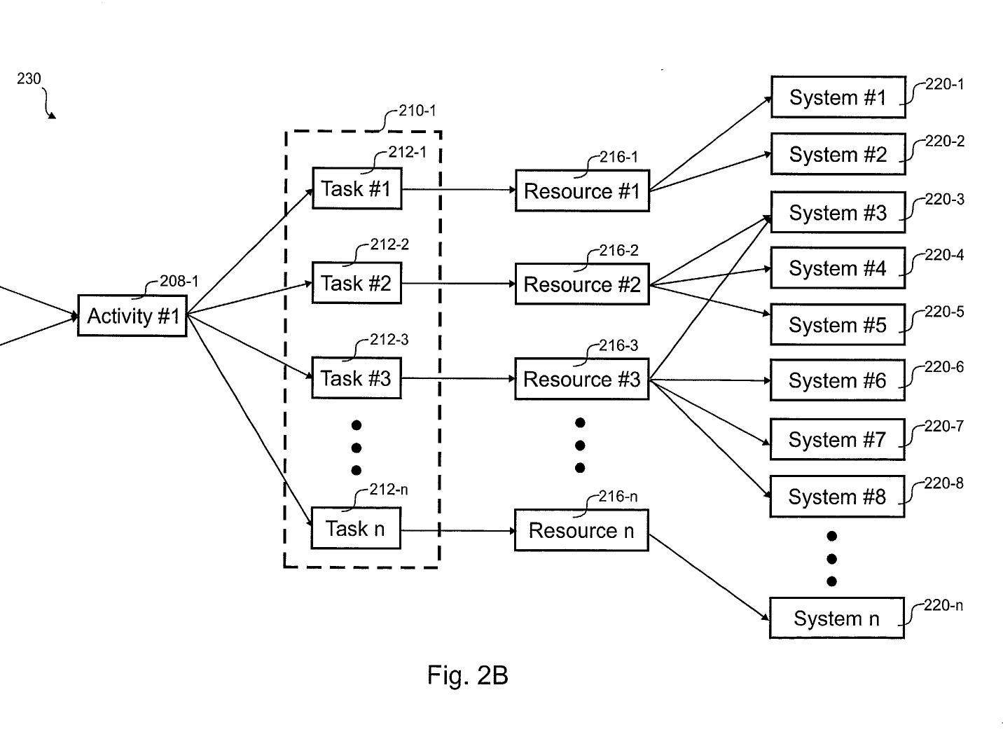

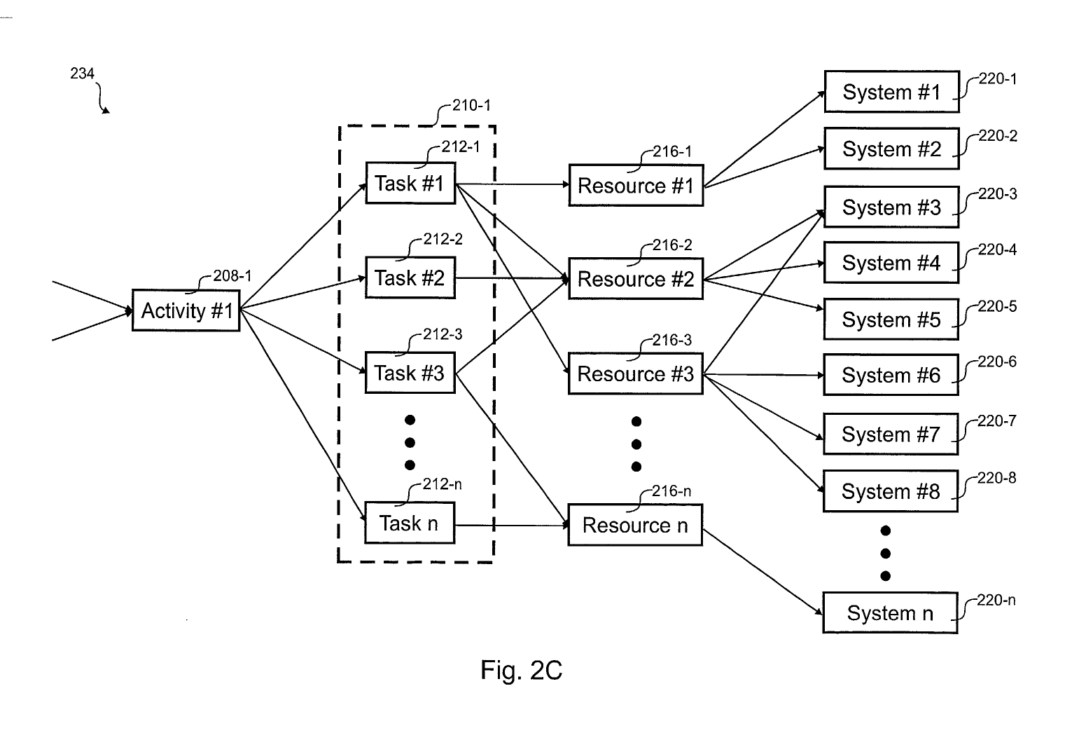

With reference to FIG. 2A, a block diagram that schematically illustrates a definition flow 200 for an embodiment of an activity-based model 100 is shown. Depicted are a number of business drivers 204, a number of activities 208, a number of task groups 210, a number of resources 216, and a number of systems 220, which form the building blocks of the modeling system 100. Each business driver 204 is associated with one or more activities 208 that are associated with a group of tasks 210. Each task in the group 210 is associated with a resource 216. A number of systems 220 are typically associated with a resource 216. By interacting with the various entry screens 108, 112, 116, 120, 124, the building blocks are entered and their interdependencies are specified. In FIG. 2A, a flow of specifying the interdependencies is shown with arrows.

After the business drivers 204 are defined as part of strategic planning, each business driver is tied to one or more activities 208. Each of those activities 208 has one or more task group 210 that perform the activity 208. In this embodiment, the second business driver 204-2 corresponds to three activities 208-1, 208-2, 208-3. The first activity 208-1 has a first task group 210-1, that are used to accomplish the first activity volume. The second activity 208-2 has a second task group 210-2 that is used to accomplish the second activity 208-2.

In this embodiment, each task in the task group 210 is linked to a resource 216. The task flows to an associated resource 216 the amount of that resource 216 the task needs (i.e., flows the demand). The first task group 210-1 uses a first resource 216-1 twice and a third resource 216-3. The first resource 216-1 uses the first, second and n^{th} systems 220-1, 220-2, 220-n. As will become clear in the discussion of the next figures, each resource 216 uses one or more systems 220 and each resource 216 may be used by multiple tasks in a task group 210 as well as tasks associated with other task groups 210.

Referring next to FIG. 2B, a block diagram that schematically illustrates a portion 230 of a definition flow 200 for an embodiment of the activity-based model 100 is shown. A single activity 208-1 is shown in this embodiment. The first task 208-1 is mapped to n tasks 212 in the task group 210. Each task 212 is mapped to a resource 216. The systems 220 are mapped to one or more resources 216. For example, the third task 212-3 is mapped to the third resource 216-3 and the third, sixth, seventh, and eighth systems 220-3, 220-6, 220-7, 220-8. Other embodiments could have other activities that use tasks 212 in the first task group 210-1. For example, the third activity 208-3 could use the third task 212-3 in the first task group 210-1 such that the third task 212-3 is associated with two activities 208-1, 208-3.

With reference to FIG. 2C, a block diagram that schematically illustrates a portion 234 of a definition flow 200 for another embodiment of an activity-based model 100 is shown. In this embodiment, each task 212 is mapped to one or more resources 216. A given resource 216 may be associated with one or more tasks 212.

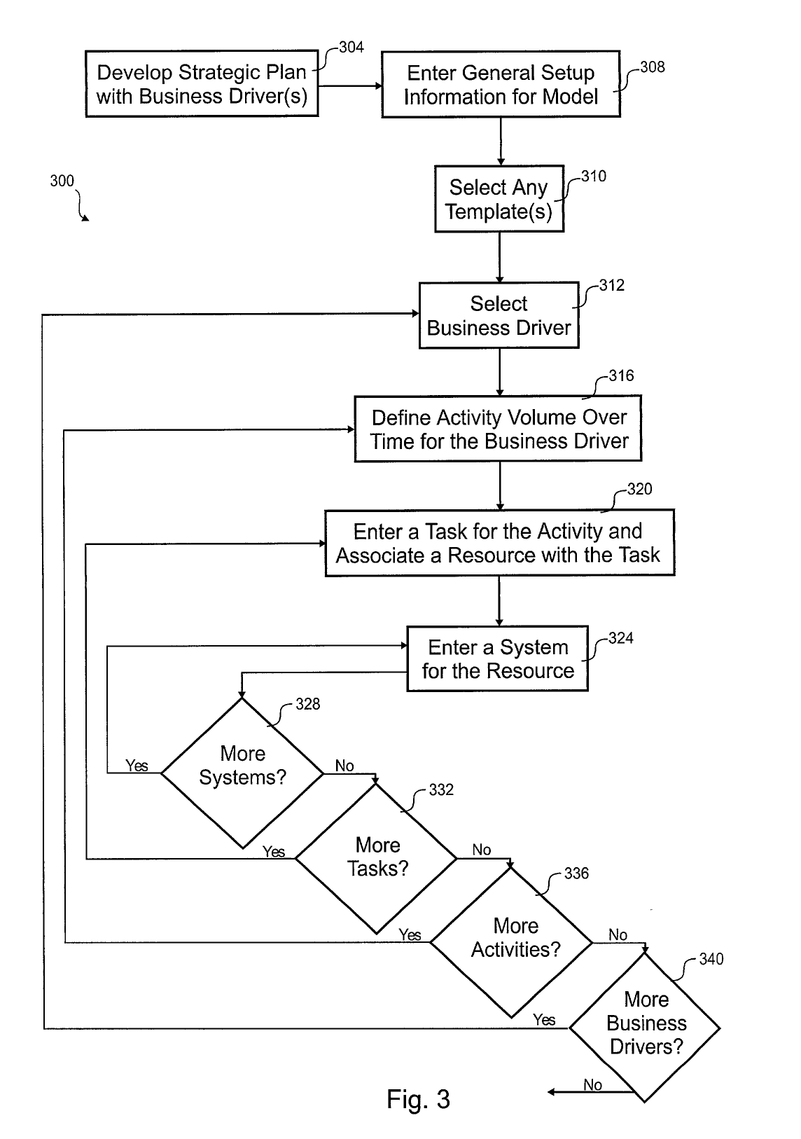

Referring next to FIG. 3, a flow diagram of an embodiment of a method 300 for modeling an activity-based system 100 is shown. In this embodiment, the process begins in step 304 where a strategic plan is developed that enumerates several business drivers 204. General setup information is entered in step 308 using the setup information entry screen 108. During the setup step 308 personnel systems 216 and some overhead expenses are defined. Templates are selected from the database of templates 144 in step 310. Some embodiments could select the templates before the setup information in step 308 because the templates 144 could include typical setup information.

In step 312, one of the business drivers 204 defined in step 304 is selected. An activity 208 is defined in step 316 as a quantity for each time period that may vary over time. The activity volume could be entered for each time period or a trend could be entered. In step 320, a task 212 is entered for the activity 208, and a resource 216 is associated with the task 212. A system 220 for the resource 212 is entered in step 324.

The user determines if more systems 220 are associated with the resource 216 in step 328. If so, processing loops back to step 324 where another system 220 is specified. If not, a further determination is made in step 332 as to whether more tasks 212 are associated with the activity 208. Where there are more tasks 212, processing loops back to step 320. Further determinations are made in steps 336 and 340 such that the user will enter any more activities and/or select any more business drivers by looping back to steps 312 and/or 316. In this way, the user iteratively enters the building blocks 204, 208, 212, 216, 220 into the modeling system 100. Those skilled in the art can appreciate, however, that the building blocks 204, 208, 216, 220 could be entered in many different orders in other embodiments.

After modeling the organization by generating forward-looking results, the actual business results can be compared with projected (or forward-looking) results produced by the modeling system 100. Where there are discrepancies, the modeling system 100 can be adjusted until the discrepancies are within the accuracy desired. If discrepancies cannot be accounted for, unknown or black box budget entries can be added to the modeling system 100.

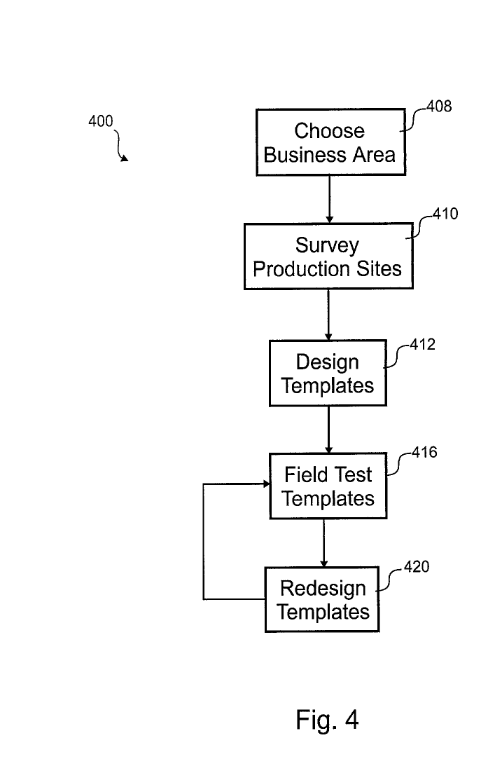

With reference to FIG. 4, a flow diagram 400 of an embodiment for designing templates used in the activity-based modeling system is shown. Templates 144 can be used to pre-populate any of the entry screens 108, 112, 116, 120, 124. Research is used to get a sampling of the possible values provided for the entry screens 108, 112, 116, 120, 124.

The template design process begins with choosing a business area that would benefit from modeling in step 408. Vendor supplied data, production sites or other sources are researched to determine typical building blocks 204, 208, 212, 216, 220 used for that business area and what values should be used for those building blocks 204, 208, 212, 216, 220. In step 412, the templates 144 are designed with the research data. Part of this design could include the design of queries and/or decision trees to assist a user in selecting the proper templates 144. In an iterative manner, steps 416 and 420 field test the templates and refine the templates with the results from the field tests. Any changes to the template database 144 can be manually or automatically disseminated to the end users to improve their modeling systems 100.

In light of the above description, a number of advantages of the present invention are readily apparent. End users can quickly model an organization without the need for any historical data from, for example, a balance sheet. Where certain data for the model is unknown, the user can rely upon pre-populated templates for typical data. Forward-looking reports are possible without balance sheet information or complete cost information.

A number of variations and modifications of the invention can also be used. For example, the activity-based modeling system could be part of another program such as Microsoft's Excel, could be a stand alone software package, or could be accessed over a network from an application service provider. Additionally, different embodiments could gather the building blocks for the modeling system in any order and could define their interrelationship at any time and in any manner.

Although the invention is described with reference to specific embodiments thereof, the embodiments are merely illustrative, and not limiting, of the invention, the scope of which is to be determined solely by the appended claims. The preceding detailed description provides those skilled in the art with an enabling description of the invention.

What is claimed is:

1. A method for activity-based business modeling for an organization, the method comprising steps of:
processing at least two of an activity entry, a task entry, a resource entry, and a system entry;
mapping together at least two of the activity entry, the task entry, the resource entry, and the system entry; and
generating a forward-looking report after the processing step and related to at least two of the activity entry, the task entry, the resource entry, and the system entry.

2. The method for activity-based business modeling for the organization as recited in claim 1, further comprising a step of attributing overhead expenses to the organization as a whole.

3. The method for activity-based business modeling for the organization as recited in claim 1, wherein the resource entry is associated with at least one system entry.

4. The method for activity-based business modeling for the organization as recited in claim 1, wherein:
at least one of the activity entry, the resource entry, the task entry, and the system entry is derived from a template; and
the template is not produced by an end user.

5. The method for activity-based business modeling for the organization as recited in claim 1, further comprising a step of retrieving at least one of the activity entry, the task entry, the resource entry, and the system entry from a predefined template.

6. The method for activity-based business modeling for the organization as recited in claim 1, wherein the organization comprises at least one of a project(s), a department(s), a whole company, and a family of companies.

7. A method for activity-based business modeling for an organization, the method comprising steps of:
processing a task entry before entry of any historical information for the organization;
processing a resource entry;
correlating the task entry to the resource entry;
generating a forward-looking report using at least one of the task entry and the resource entry.

8. The method for activity-based business modeling for the organization as recited in claim 7, further comprising a step of processing an activity entry.

9. The method for activity-based business modeling for the organization as recited in claim 7, further comprising a step of processing a system entry.

10. The method for activity-based business modeling for the organization as recited in claim 9, further comprising a step of determining a demand for the system entry for an activity volume.

11. The method for activity-based business modeling for the organization as recited in claim 7, wherein the forward-looking report is chosen from the group consisting of:
a head count report, a multi-year projection, and an activity-based costing report.

12. The method for activity-based business modeling for the organization as recited in claim 7, further comprising steps of:
processing an activity entry; and
processing a system entry, wherein:
at least one of the activity entry, the resource entry, the task entry, and the resource entry is derived from a template; and
the template is not produced by an end user.

13. An activity-based business modeling program product for an organization, the program product comprising:
code for processing at least two of an activity entry, a task entry, a resource entry, and a system entry;
code for mapping together at least two of the activity entry, the task entry, the resource entry, and the system entry;
code for generating a forward-looking report after the processing step and related to at least two of the activity entry, the task entry, the resource entry, and the system entry; and
a machine-readable medium comprising the codes.

14. The activity-based business modeling program product for the organization as recited in claim 13, further comprising code for attributing overhead expenses to the organization as a whole.

15. The activity-based business modeling program product for the organization as recited in claim 13, wherein the resource entry is associated with at least one system entry.

16. The activity-based business modeling program product for the organization as recited in claim 13, wherein:
at least one of the activity entry, the resource entry, the task entry, and the system entry is derived from a template; and
the template is not produced by an end user.

17. The activity-based business modeling program product for the organization as recited in claim 13, further comprising code for retrieving at least one of the activity entry, the task entry, the resource entry, and the system entry from a predefined template.

18. The activity-based business modeling program product for the organization as recited in claim 13, wherein the organization comprises at least one of a project(s), a department(s), a whole company, and a family of companies.
